(19) United States
(12) Patent Application Publication
(10) Pub. No.: US 2011/0003719 A1
(43) Pub. Date: Jan. 6, 2011

(54) POLYMER-CONTAINING COMPOSITION, ITS PREPARATION AND USE

(75) Inventors: Robin Winters, Bemmel (NL); Elwin Schomaker, Arnhem (NL); Siebe Cornelis De Vos, Arnhem (NL)

Correspondence Address: KENYON & KENYON LLP, ONE BROADWAY, NEW YORK, NY, 10004, US

(73) Assignee: Akzo Nobel N.V.

(21) Appl. No.: 12/918,926

(22) PCT Filed: Mar. 9, 2009
(86) PCT No.: PCT/EP2009/052694

§ 371 Date: Aug. 23, 2010

Related U.S. Application Data
(60) Provisional application No. 61/038,244, filed on Mar. 20, 2008.

(30) Foreign Application Priority Data
Mar. 12, 2008 (EP) 08152640.2

(51) Int. Cl. C08G 63/08; C08L 67/00; C08L 23/00; C08L 69/00; C08L 5/00; C09D 11/10; C11D 3/37; C09K 8/24; C04B 26/18; D21H 17/46

(52) U.S. Cl. 507/117; 528/274; 525/410; 525/186; 525/413; 525/411; 524/27; 524/612; 510/475; 524/4; 162/164.1

(57) ABSTRACT

Process for the preparation of a polymer-containing composition comprising the steps of: a) preparing a mixture of at least one cyclic monomer selected from glycolide and lactide and a layered double hydroxide comprising as charge-balancing anions 10 to 100% of an organic anion and 0 to 90% of hydroxide, based on the total amount of charge-balancing anions, and b) polymerising said monomer, optionally in the presence of a polymerisation initiator or catalyst.

The present invention relates to a process for the preparation of a polymer-containing composition in the presence of a layered material. More in particular, this process involves ring-opening polymerisation of at least one cyclic monomer selected from lactide and glycolide in the presence of a clay. The invention further relates to a composition obtainable by this process and the use of this composition.

An example of a polymer that can be prepared by ring-opening polymerisation is the aliphatic polyester poly(ε-caprolactone) (PCI). Its synthesis is initiated through a ring-opening reaction in which the carbonyl group of the lactone monomer is attacked by acid, amine, or alcohol. This polymer has a highly crystalline structure and is biodegradable and non-toxic. It is widely used in packaging and medical supplies, including degradable packaging, controlled release of drugs, and orthopaedic casts. Although PCI is readily processable and has good compatibility with other polymers, its low melting point (60° C.) has limited its use in many applications. Thus caprolactone has been blended with other polymers or co-polymerised with other monomers to expand its usage.

In order to improve the properties of polymers, nano-sized particles can be introduced, resulting in so-called polymer-based nanocomposites. In general, the term “nanocomposites” refers to a composite material wherein at least one component comprises an inorganic phase with at least one dimension in the 0.1 to 100 nanometer range. One class of polymer-based nanocomposites (PNCs) comprises hybrid organic-inorganic materials derived from the incorporation of small quantities of extremely thin nanometer-sized inorganic particles of high aspect ratio into a polymer matrix. Additions of small amounts of nanoparticles are effective in upgrading otherwise mutually exclusive properties of polymers, such as strength and toughness. A major advantage of this class of nanocomposites is that they simultaneously improve material properties which are usually trade-offs. On top of their improved strength-to-weight ratios as compared to polymers filled with conventional mineral fillers, PNCs exhibit improved flame resistance, better high temperature stability, and better dimensional stability. In particular, a significant reduction of the coefficient of expansion is of practical interest in automotive applications. Improved barrier properties and transparency are unique assets of nanocomposites, e.g., for packaging foil, bottles, and fuel system applications.

Suitable nanosized particles to be present in PNCs include delaminated clay layers. Such clay-containing PNCs can be prepared by polymerising monomers in the presence of clays, as disclosed in the prior art.

Ring-opening polymersation of cyclic monomers in the presence of cationic clays, such as montmorillonite, is disclosed by B. Lepoittevin et al., Polymer 44 (2003) 2033-2040. Cationic clays are layered materials having a crystal structure consisting of negatively charged layers built up of specific combinations of tetravalent, trivalent, and, optionally, divalent metal hydroxides between which there are cations and water molecules. The layers of montmorillonite are built up of Si, Al, and Mg hydroxides. According to the above disclosure, montmorillonite was stirred with ε-caprolactone and heated at 100° C. in the presence of Bu₂(MeO)₂, the latter serving as a catalyst for ring-opening polymerisation. The extent of intercalation and/or delamination of the montmorillonite depended on the montmorillonite concentration in the caprolactone mixture and the nature of its interlayer cations.

D. Kubies et al., Macromolecules 35 (2002) 3318-3320, polymerise ε-caprolactone in the presence of Cloisite 25A (N,N,N,N-dimethyldodecyl-octadecyl-ammonium montmorillonite) or N,N-diethyl-N-3-hydroxypropyl-octadecyl-ammonium bromide-exchanged montmorillonite. Tin(II) octoate or dibutyltin(IV) dimethoxide was used as catalyst.

N. Pantoustier et al., Polymer Engineering and Science 42 (2002) 1928-1937, show that ε-caprolactone can be polymerised at 170° C. in the presence of Na⁺-montmorrilonite without addition of a catalyst such as tin(II) octoate or dibutyltin(IV) dimethoxide. They theorise that this is due to activation of the monomer through interaction with acidic sites on the clay surface.

WO 2006/000550 discloses a process for the polymerisation of cyclic monomers, such as lactide and glycolide, using a layered double hydroxide comprising solely inorganic charge-balancing anions.

It is an object of the present invention to provide an improved process for preparing polymer-containing compositions from a cyclic monomer, in particular lactide and glycolide. It is a further object of the present invention to provide a process for the stereospecific preparation of poly(L-lactide) and poly(L-lactide/-glycolide).

The present invention therefore relates to a process for the preparation of a polymer-containing composition comprising the steps of:

a) preparing a mixture of at least one cyclic monomer selected from glycolide and lactide and a layered double hydroxide comprising as charge-balancing anions 10 to 100% of an organic anion and 0 to 90% of hydroxide, based on the total amount of charge-balancing anions, and
b) polymerising said monomer, optionally in the presence of a polymerisation initiator or catalyst.
The polymer-containing composition produced with the process of the invention generally is a nanocomposite material wherein the layered double hydroxide (LDH) is delaminated and/or exfoliated. The organic charge-balancing anion causes the LDH to have an improved compatibility with the cyclic monomers and/or the resulting polymer. In addition, the process of the present invention allows the preparation of stereospecific poly L-lactide (PLLA). This in contrast to conventional LDHs with inorganic charge-balancing anions, such as hydrotalcite, which result in racemised polylactide.
Further, the process according to the present invention is simple, industrially feasible, and economically attractive. The layered double hydroxide can serve as initiator for the ring-opening polymerisation of the cyclic monomer. These LDHs can enhance the polymerisation rate and can also influence the properties of the polymer such as an increase of the weight average molecular weight.

In this specification, the term “polymer” refers to an organic substance of at least two building blocks (i.e. monomers), thus including oligomers, copolymers, and polymeric resins.

The term “cyclic monomer” in this specification includes cyclic dimers, trimers or tetramers. Suitable cyclic monomers for use in the process according to the present invention include lactide (the cyclic diester of lactic acid), glycolide (the dimeric ester of glycolic acid), and combinations of these monomers. The term lactide includes L,L-lactide, D,D-lactide, mesolactide, and mixtures thereof.

Within the context of this specification the term “charge-balancing anion” refers to anions that compensate for the electrostatic charge deficiencies of the crystalline LDH sheets. As the LDH typically has a layered structure, the charge-balancing anions may be situated in the interlayer, on the edge or on the outer surface of the stacked LDH layers. Anions situated in the interlayer of stacked LDH layers are referred to as intercalating ions.

An LDH comprising organic intercalating anions, also called organoclays, may be delaminated or exfoliated, e.g. in a polymeric matrix. Within the context of the present specification the term “delamination” is defined as a reduction of the mean stacking degree of the LDH sheets by at least partial de-layering of the LDH structure, thereby yielding a material containing significantly more individual LDH sheets per volume. The term “exfoliation” is defined as complete delamination, i.e. the disappearance of periodicity in the direction perpendicular to the LDH sheets, leading to a random dispersion of individual layers in a medium, thereby leaving no stacking order at all. Swelling or expansion of the LDH, also called intercalation, can be observed with X-ray diffraction (XRD), because the position of the basal reflections—i.e. the d(00l) reflections—is indicative of the distance between the layers, which distance increases upon intercalation.

Reduction of the mean stacking degree can be observed as a broadening, up to disappearance, of the XRD reflections or by an increasing asymmetry of the basal reflections (00l).
Characterisation of complete delamination, i.e. exfoliation, remains an analytical challenge, but may in general be concluded from the complete disappearance of non-(hk0) reflections from the original LDH.
The ordering of the layers and, hence, the extent of delamination, can further be visualised with transmission electron microscopy (TEM).

The layered double hydroxides have a layered structure corresponding to the general formula:

└Mₘ²⁺Mₙ³⁺(OH)₂ₘ₊₂ₙ┘X_{n/z}^{z-}·bH₂O (I)

wherein M²⁺is a divalent metal ion such as Zn²⁺, Mn²⁺, Ni²⁺, Co²⁺, Fe²⁺, Cu²⁺, Sn²⁺, Ba²⁺, Ca²⁺, Mg²⁺, and mixtures thereof; M³⁺is a trivalent metal ion such as Al³⁺, Cr³⁺, Fe³⁺, Co³⁺, Mn³⁺, Ni³⁺, Ce³⁺, Ga³⁺, and mixtures thereof; m and n have a value such that m/n=1 to 10, preferably 1 to 6, more preferably 2 to 4; b has a value in the range of from 0 to 10, preferably 2 to 6; and X^{Z-}is the charge-balancing anion. Preferably, M²⁺is Mg²⁺, M³⁺is Al³⁺.
The charge-balancing organic anion present in the LDH used in the process of the invention can be any suitable organic anion known in the art. Such organic anions include mono-, di- or polycarboxylic acids, sulfonic acids, phosphonic acids, and sulfate acids. Preferably, the organic anion comprises at least 2 carbon atoms, more preferably at least 8 carbon atoms, even more preferably at least 10 carbon atoms, and most preferably at least 12 carbon atoms; and the organic anion comprises at most 1,000 carbon atoms, preferably at most 500 carbon atoms, more preferably at most 100 carbon atoms, and most preferably at most 50 carbon atoms.
It is further contemplated that the charge-balancing organic anion comprises one or more additional functional groups, such as hydroxyl, amine, carboxylic acid, and vinyl, which may interact or react with the polymer.
Suitable examples of organic anions are monocarboxylic acids such as fatty acids and rosin-based ions.
In one embodiment, the organic anion is a fatty acid having from 8 to 22 carbon atoms. Such a fatty acid may be a saturated or unsaturated fatty acid. Suitable examples of such fatty acids are caprylic acid, capric acid, lauric acid, myristic acid, palmitic acid, stearic acid, arachidic acid, decenoic acid, palmitoleic acid, oleic acid, linoleic acid, linolenic acid, and mixtures thereof.
In another embodiment of the present invention, the organic anion is rosin. Rosin is derived from natural sources, is readily available, and is relatively inexpensive compared to synthetic organic anions. Typical examples of natural sources of rosin are gum rosin, wood rosin, and tall oil rosins. Rosin commonly is a suspension of a wide variety of different isomers of monocarboxylic tricyclic rosin acids usually containing about 20 carbon atoms. The tricyclic structures of the various rosin acids differ mainly in the position of the double bonds. Typically, rosin is a suspension of substances comprising levopimaric acid, neoabietic acid, palustric acid, abietic acid, dehydroabietic acid, secodehydroabietic acid, tetrahydroabietic acid, dihydroabietic acid, pimaric acid, and isopimaric acid. Rosin derived from natural sources also includes rosins, i.e. rosin suspensions, modified notably by polymerisation, isomerisation, disproportionation, hydrogenation, and Diels-Alder reactions with acrylic acid, anhydrides, and acrylic acid esters. The products obtained by these processes are referred to as modified rosins. Natural rosin may also be chemically altered by any process known in the art, such as for example reaction of the carboxyl group on the rosin with metal oxides, metal hydroxides or salts to form rosin soaps or salts (so-called resinates). Such chemically altered rosins are referred to as rosin derivatives.
Such rosin can be modified or chemically altered by introducing an organic group, an anionic group or a cationic group. The organic group may be a substituted or unsubstituted aliphatic or aromatic hydrocarbon having 1 to 40 carbon atoms. The anionic group may be any anionic group known to the man skilled in the art, such as a carboxylate or a sulfonate.
In one embodiment, the organic anions are a mixture of fatty acid and rosin. Preferably, at least 10% of the total amount of intercalating anions is a fatty acid-derived or a rosin-based anion or a suspension of both anions, preferably at least 30%, more preferably at least 60%, and most preferably at least 90% of the total amount of intercalating ions is a fatty acid-derived or a rosin-based anion or a mixture of both anions.

At least 10% of the total amount of intercalating ions in the LDH used in the process according to the invention is an organic anion, preferably at least 30%, more preferably at least 60%, and most preferably at least 90% of the total amount of intercalating ions is an organic anion. Hydroxide as charge-balancing anion may be present in addition to the organic anion in an amount of from 0 to 90%, based on the total amount of intercalating anions, preferably at most 70%, more preferably at most 40%, and most preferably at most 10% of the total amount of charge-balancing anions.

The layered double hydroxide used in the process of the invention preferably has a distance between the individual layers of above 1.5 nm. Such interlayer distance renders the layered double hydroxides easily processable in the polymeric matrix, and it further enables easy delamination and/or exfoliation of the layered double hydroxide, resulting in a mixture of the layered double hydroxide and the polymer matrix with improved physical properties. Preferably, the distance between the layers in an LDH is at least 1.5 nm, more preferably at least 1.6 nm, even more preferably at least 1.8 nm, and most preferably at least 2 nm. The distance between the individual layers can be determined using X-ray diffraction and transmission electron microscopy (TEM), as outlined above.

The process of the invention demonstrates stereospecific catalysing properties in the polymerisation of cyclic monomers such as L,L-lactide to PLLA. Conventional hydrotalcite, which comprises carbonate as charge-balancing anion, causes racemisation of the cyclic monomers, which may be undesirable. For instance, in the case of L,L-lactide racemisation leads to an amorphous polymer. The use of an LDH comprising organic charge-balancing anions in the polymerisation of L,L-lactide leads to racemisation being prevented while polymerisation takes place, resulting in polymers with improved physical and mechanical properties.

If desired, a polymerisation initiator or catalyst may be added to the mixture. A polymerisation initiator is defined as a compound which is able to start ring-opening polymerisation and from which the polymeric chain grows. Examples of such initiators for ring-opening polymerisation are alcohols. A polymerisation catalyst (also called activator) is a compound that increases the growth rate of the polymeric chain. Examples of such catalysts are organometallic compounds such as tin(II) 2-ethylhexanoate (commonly referred to as tin(II) octoate), tin alkoxides (e.g. dibutyltin(IV) dimethoxide), aluminium tri-isopropoxide, and lanthanide alkoxides.

Although the layered double hydroxide present in the process according the present invention may act as a polymerisation initiator or catalyst, the terms “polymerisation initiator” and “polymerisation catalyst” in the present specification do not include said layered double hydroxide.

Polymerisation initiators or catalysts can be present in the mixture in an amount of 0-10 wt %, more preferably 0-5 wt %, even more preferably 0-1 wt %, based on the weight of cyclic monomer. However, the use of such initiators or catalysts is not required and may incur additional costs and contamination of the resulting composition. Especially if medical or biodegradable applications of the resulting product are envisaged, polymerisation initiator or catalyst residues can have harmful effects. Hence, most preferably, no conventional polymerisation initiator or catalysts such as the above organometallic compounds are used in the process of the invention.

In one embodiment of the present invention, the process uses both LDH containing an organic charge-balancing anion and 10-90 wt %, preferably 15-80 wt %, most preferably 20-70 wt %, based on the total weight of LDH, of an LDH having only inorganic charge-balancing anions, such as hydroxide, nitrate, chloride, bromide, sulfonate, sulfate, bisulfate, phosphate, or combinations thereof. Most preferably, the inorganic charge-balancing anion is selected from the group consisting of hydroxide, nitrate, chloride, bromide, sulfate, and combinations thereof.

The mixture of step a) is prepared by mixing the layered double hydroxide with the cyclic monomer. Depending on whether the cyclic monomer is liquid or solid at the mixing temperature, and depending on whether or not solvents are added, this mixing results in a suspension, a paste, or a powder mixture.

The amount of layered double hydroxide in the mixture of step a) preferably is 0.01-75 wt %, more preferably 0.05-50 wt %, even more preferably 0.1-30 wt %, based on the total weight of the mixture.

Layered double hydroxide amounts of 1-10 wt %, more preferably 1-5 wt %, are especially advantageous for the preparation of polymer-based nanocomposites, i.e. polymer-containing compositions according to the invention that contain delaminated—up to exfoliated—layered double hydroxide.
Layered double hydroxide amounts of 10-50 wt % are especially advantageous for the preparation of so-called masterbatches applicable for, e.g., polymer compounding. Although the layered double hydroxide in such masterbatches in general is not completely delaminated, further delamination may be reached in a later stage, if so desired, when blending the masterbatch with a further polymer.
Commercial layered double hydroxide is generally delivered as free-flowing powder. No special treatment, such as drying, of such free-flowing powder is required before its use in the process according to the invention.
Even the cyclic monomer, which as a rule must be dried (e.g. over CaH₂) before its use in everyday processes, does not require a drying step before its use in the process according to the invention.

In addition to the layered double hydroxide and the cyclic monomer(s), the mixture of step a) may contain pigments, dyes, UV-stabilisers, heat-stabilisers, anti-oxidants, fillers (such as hydroxyapatite, silica, graphite, glass fibres, and other inorganic materials), flame retardants, nucleating agents, impact modifiers, plasticisers, rheology modifiers, cross-linking agents, and degassing agents. These optional addenda and their corresponding amounts can be chosen according to need.

Also solvents may be present in the mixture. Suitable solvents are all solvents that do not interfere with the polymerisation reaction. Examples of suitable solvents are ketones (such as acetone, alkyl amyl ketones, methyl ethyl ketone, methyl isobutyl ketone, and diisobutyl ketone), 1-methyl-2-pyrrolidinone (NMP), dimethyl acetamide, ethers (such as tetrahydrofuran, (di)ethylene glycol dimethyl ether, (di)propylene glycol dimethyl ether, methyl tert.-butyl ether, aromatic ethers, e.g. Dowtherm™, as well as higher ethers), aromatic hydrocarbons (such as solvent naphthas (ex Dow), toluene, and xylene), dimethyl sulfoxide, hydrocarbon solvents (such as alkanes and mixtures thereof such as white spirits and petroleum ethers, and halogenated solvents (such as dichlorobenzene, perchloroethylene, trichloroethylene, chloroform, dichloro-methane, and dichloroethane).

Reactive species not belonging to the class of cyclic monomers that can interfere with the polymerisation reaction or react with the product of the process may be added deliberately to the mixture in step a) or during step b), in order to control the molecular weight and/or the architecture of the polymers formed during the process of the invention. For example, non-cyclic esters may be added, functioning as, e.g., co-monomer. Furthermore, a compound may be added that limits the average molecular weight by terminating the polymerisation process; an example of such a compound is an alcohol. It is also possible to add a reagent that has the ability to react more than once, thereby facilitating the formation of branched polymer chains or even gelled networks.

It is also possible to add polymers to the mixture in step a). Suitable polymers include aliphatic polyesters such as poly(butylene succinate), poly(butylene succinate adipate), poly(hydroxybutyrate), and poly(hydroxyvalerate), aromatic polyesters such as poly(ethylene terephthalate), poly(butylene terephthalate), and poly(ethylene naphthalate), poly(orthoesters), poly(ether esters) such as poly(dioxanone), polyanhydrides, (meth)acrylic polymers, polyolefins, vinyl polymers such as poly(vinylchloride), poly(vinylacetate), poly(ethylene oxide), poly(acrylamide), and poly(vinylalcohol), polycarbonates, polyamides, polyaramids such as Twaron®, polyimides, poly(amino acids), polysaccharide-derived polymers such as (modified) starches, cellulose, and xanthan, polyurethanes, polysulfones, and polyepoxides.

The polymerisation is preferably conducted by heating the mixture of layered double hydroxide and cyclic monomer to a temperature of at least the melting point of the cyclic monomer and of the resulting polymer. Preferably, the mixture is heated to a temperature in the range 20-300° C., more preferably 50-250° C., and most preferably 70-200° C. This heating is preferably conducted for 10 seconds up to 24 hours, more preferably 1 minute to 6 hours, depending on the temperature, the type of cyclic monomer, the composition of the mixture, and the device employed. For instance, if the process is performed in an extruder, heating times in the range of seconds up to minutes can be realistically applied, depending on the temperature and the type(s) of cyclic monomer(s) employed and other components in the mixture.

The process can be conducted under inert atmosphere, e.g. N₂ atmosphere, but this is not necessary.

The process according to the invention can be conducted in various types of polymerisation equipment, such as stirred flasks, tube reactors, extruders, etc. The mixture is preferably stirred during the process in order to homogenise the contents and the temperature of the mixture.
The process according to the invention may be conducted batchwise or continuously. Suitable batch reactors are stirred flasks and tanks, batch mixers and kneaders, blenders, batch extruders, and other agitated vessels. Suitable reactors for conducting the process in a continuous mode include tube reactors, twin- or single-screw extruders, plow mixers, compounding machines, and other suitable high-intensity mixers.

If so desired, the composition obtained from step b) may be modified in order to make it more suitable for subsequent application, for instance to improve its compatibility with the polymeric matrix into which it may subsequently be incorporated. Such modifications can include transesterification, hydrolysis, or alcoholysis of the polymer formed during the process of the present invention, or reactions with reagents that are reactive with hydroxyl groups, such as acids, anhydrides, isocyanates, epoxides, lactones, halogen acids, and inorganic acid halides in order to modify the polymeric end groups.

In a further embodiment, the composition obtained from step b), optionally after the above modification step, can be incorporated into a polymer matrix by mixing or blending said composition with a melt or solution of such matrix polymer.

Suitable polymers for matrixing purpose include aliphatic polyesters such as poly(butylene succinate), poly(butylene succinate adipate), poly(hydroxy-butyrate), and poly(hydroxyvalerate), aromatic polyesters such as poly(ethylene terephthalate), poly(butylene terephthalate), and poly(ethylene naphthalate), poly(orthoesters), poly(ether esters) such as poly(dioxanone), polyanhydrides, (meth)acrylic polymers, polyolefins (e.g polyethylene, polypropylene, and copolymers thereof), vinyl polymers such as poly(vinylchloride), poly(vinyl-acetate), poly(ethylene oxide), poly(acrylamide) and poly(vinylalcohol), polycarbonates, polyamides, polyaramids such as Twaron®, polyimides, poly(amino acids), polysaccharide-derived polymers such as (modified) starches, cellulose, and xanthan, polyurethanes, polysulfones, and polyepoxides.
This incorporation can result in further delamination of the intercalated or delaminated layered double hydroxide.

The polymer-containing composition obtainable by the above process can be added to coating, ink, resin, cleaning, or rubber formulations, drilling fluids, cements or plaster formulations, or paper pulp. They can also be used in or as a thermoplastic resin, in or as a thermosetting resin, and as a sorbent.

Polymer-containing compositions obtainable by the process of the present invention can be used for the production of, e.g., adhesives, surgical and medical instruments, synthetic wound dressings and bandages, foams, (biodegradable) objects (such as bottles, tubings or linings) or films, material for controlled release of drugs, pesticides, or fertilisers, non-woven fabrics, orthoplastic casts, and porous biodegradable materials for guided tissue repair or for support of seeded cells prior to implantation.

It is also possible to heat the polymer-containing composition in order to remove the organic compounds, thereby leaving a ceramic material, e.g. a porous oxide, which can be used as or in a catalyst or sorbent composition, optionally after a shaping and/or coating step.

### EXAMPLES

### Example 1

200 grams of L-lactide (Purasorb L, ex Purac Biochem BV) were charged to a 500 ml 3-necked round bottom flask equipped with a mechanical stirrer, a thermometer/thermostat, and a nitrogen flush. 5 grams of an Mg—Al LDH having as charge-balancing anions about 14 mol % OH⁻, 43 mol % C₁₆ fatty acid, and about 43 mol % C₁₈ fatty acid (Perkalite™ F100, ex Akzo Nobel Polymer Chemicals BV) were added to the L-lactone. The reaction mixture was heated to 160° C. using an electrical heating mantle and the L-lactone in the suspension polymerised while stirring the mixture during 6 hours. After 1 hr reaction, the suspension became completely transparent, indicating a well dispersed nanocomposite.

The resulting polymer-containing composition was semi-crystalline with a melting point of approximately 124° C., as determined by means of differential scanning calorimetry. Proton NMR revealed a nearly pure poly-L-lactide.

Pure L-lactide did not show any sign of thermal polymerisation within 6 hours at 160° C. in the absence of the LDH.

### Comparative Example 2

Example 1 was repeated using a hydrotalcite having carbonate ions instead of organic anions as charge-balancing anions. This resulted in an amorphous racemic form of polylactide, i.e. poly(D,L-lactide).

1. A process for the preparation of a polymer-containing composition comprising the steps of:
a) preparing a mixture of at least one cyclic monomer selected from glycolide and lactide, and a layered double hydroxide comprising as charge-balancing anions 10 to 100% of an organic anion and 0 to 90% of hydroxide, based on the total amount of charge-balancing anions, and
b) polymerising said monomer.

2. The process according to claim 1 wherein the lactide is L-lactide.

3. The process according to claim 2 wherein the polymer is poly(L-lactide) or poly(L-lactide/glycolide).

4. The process according to claim 1 wherein the layered double hydroxide comprises as charge-balancing anions 100% of an organic anion.

5. The process according to claim 1 wherein the organic charge-balancing anion is selected from the group consisting of fatty acids, rosin-based anions, and combinations thereof.

6. The process according to claim 1 wherein the polymerising occurs in the presence of a polymerisation initiator or catalyst.

7. The process according to claim 1 wherein the mixture of step a) further comprises one or more polymers.

8. The process according to claim 7 wherein the one or more polymer(s) is/are selected from the group consisting of polyolefins, aliphatic and aromatic polyesters, poly(ether esters), vinyl polymers, (meth)acrylic polymers, polycarbonates, polyamides, polyaramids, polyimides, poly(amino acids), polysaccharide-derived polymers, polyurethanes, polysulfones, and polyepoxides.

9. A polymer-containing composition obtained by the process according to claim 1.

10. A method comprising adding the polymer-containing composition according to claim 9 to a coating, ink, cleaning, rubber, or resin formulation, drilling fluid, cement formulation, plaster formulation, or paper pulp.

11. (canceled)

12. The process according to claim. 2 wherein the layered double hydroxide comprises as charge-balancing anions 100% of an organic anion.

13. The process according to claim 3 wherein the layered double hydroxide comprises as charge-balancing anions 100% of an organic anion.

14. The process according to claim 3 wherein the organic charge-balancing anion is selected from the group consisting of fatty acids, rosin-based anions, and combinations thereof.

15. The process according to claim 4 wherein the organic charge-balancing anion is selected from the group consisting of fatty acids, rosin-based anions, and combinations thereof.

16. The process according to claim 5 wherein the polymerising occurs in the presence of a polymerisation initiator or catalyst.

17. The process according to claim 4 wherein the mixture of step a) further comprises one or more polymers.

18. The process according to claim 6 wherein the mixture of step a) further comprises one or more polymers.

19. The process according to claim 17 wherein the one or more polymer(s) is/are selected from the group consisting of polyolefins, aliphatic and aromatic polyesters, poly(ether esters), vinyl polymers, (meth)acrylic polymers, polycarbonates, polyamides, polyaramids, polyimides, poly(amino acids), polysaccharide-derived polymers, polyurethanes, polysulfones, and polyepoxides.

20. The process according to claim 18 wherein the one or more polymer(s) is/are selected from the group consisting of polyolefins, aliphatic and aromatic polyesters, poly(ether esters), vinyl polymers, (meth)acrylic polymers, polycarbonates, polyamides, polyaramids, polyimides, poly(amino acids), polysaccharide-derived polymers, polyurethanes, polysulfones, and polyepoxides.

21. A polymer-containing composition obtained by the process according to claim 7.
